(19) United States
(12) Patent Application Publication
(10) Pub. No.: US 2006/0119598 A1
(43) Pub. Date: Jun. 8, 2006

(54) System and method for communicating travel progress within a virtual environment

(75) Inventor: Andrew Littlefield, San Francisco, CA (US)

Correspondence Address: FLIESLER MEYER, LLP, FOUR EMBARCADERO CENTER, SUITE 400, SAN FRANCISCO, CA, 94111, US

(73) Assignee: Evil Twin Studios, Inc., San Francisco, CA (US)

(21) Appl. No.: 11/292,665

(22) Filed: Dec. 2, 2005

Related U.S. Application Data
(60) Provisional application No. 60/634,705, filed on Dec. 8, 2004.

(51) Int. Cl. G06T 15/00

(52) U.S. Cl. 345/419

(57) ABSTRACT

A system and method for using cinematic montages to communicate travel progress inside a virtual environment. The invention is generally related to virtual environments, gaming environments, online communities, and interactive computing, and is specifically related to the use of cinematic montages to communicate travel progress inside a virtual environment.

### CLAIM OF PRIORITY

This application claims priority to U.S. Provisional Application No. 60/634,705 entitled “System and Method for Communicating Travel Progress Within A Virtual Environment” by Andrew Littlefield, filed Dec. 8, 2004 [Attorney Docket No. EVTWS-01003US0].

### CROSS REFERENCES

This application is related to U.S. patent application Ser. No. 11/244,850 entitled “System and Method for Integration of Instant Messaging and Virtual Environment Client” by Andrew Littlefield, filed Oct. 6, 2005 [Attorney Docket No. EVTWS-01000US1]; U.S. patent application Ser. No. ______ entitled “System and Method for Organizing Online Communities and Virtual Dwellings Within a Virtual Environment” by Andrew Littlefield, filed Dec. 2, 2005 [Attorney Docket No. EVTWS-01001 US1]; and U.S. patent application Ser. No. ______ entitled “System and Method For Communicating Object Status Within a Virtual Environment Using Translucency” by Andrew Littlefield, Filed Dec. 2, 2005 [Attorney Docket No. EVTWS-01002US1].

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention is generally related to virtual environments, gaming environments, online communities, and interactive computing, and is specifically related to the use of cinematic montages to communicate travel progress inside a virtual environment.

### BACKGROUND

Virtual Environments

A virtual environment is a computer-simulated environment intended for its users to inhabit and interact with via avatars. This habitation usually is represented in the form of two or three-dimensional graphical representations of humanoids (or other graphical or text-based avatars). Some, but not all, virtual worlds allow for multiple users.

The world being simulated typically appears similar to the real world, with real world rules such as gravity, topography, locomotion, real-time, and communication.

The earliest instances of virtual environments can be traced back to 1978, when Roy Trubshaw introduced the first release of the Multi User Dungeon (MUD) program. MUD was purely text based, relied upon textual descriptions of the virtual environments and characters, with users interacting via text commands also. An example of a MUD gaming session is shown in FIG. 1.

MUD allowed multiple users (or game characters) to explore the same virtual world simultaneously. It also allowed characters to interact with each other in various forms ranging from conversation to a fight to the death. Users could interact with environmental objects, in which case the system provided stateful tracking of those objects (e.g. a player can drop a coin in a room, and should another player visit that same room at a later time they will be able to see that same coin object and interact with it). The MUD program also allowed players to create their own virtual environments and game spaces using a built-in scripting language so allowing expansion of the virtual environment by end users. This extensibility coupled with strong game play elements proved to be very popular at the time of release, with several MUD deployments still in use today. More importantly the MUD provided the functional blueprints on which many virtual environments still utilize to this day.

The popularity of the original MUD did not go unnoticed by commercial vendors, who developed the second generation of virtual environments in the mid eighties. This second generation of virtual worlds, leveraged the same text based interaction model and the same basic game play elements as MUD. However this second generation differed from the first in terms of the scale of the virtual environments and the maximum number of simultaneous users that the virtual worlds could support.

This second generation of virtual environments were introduced to the general public in the U.S. and in Europe by the then dominant online providers, including Compuserve, Prestel and CompuNet. These initial commercial offerings proved to be massive initial success in the US where flat rate local phone calls where commonplace so allowing gamers to connect to local POPs with zero incremental costs. However in the UK and most of Europe local telephone calls where charged by the minute, and so resulting in extensive telephone bills. The popularity of these games/virtual environments allowed CompuServe to capture over one million users over a period of three years. Other online services, including AOL soon followed suit and offered similar environments as part of their service offerings. AOL soon rose to become the dominant online service provider in the US and virtual environments remained a major part of the offerings made to users. This resulted in AOL becoming the preeminent distribution channel for virtual world developers as the AOL user base grew to dwarf the other online providers. The reliance upon a single distribution channel left many virtual world developers in a vulnerable position and would eventually cause their demise.

Many of these free virtual environments were running variants of TinyMUD developed by Jim Aspnes at Carnegie Mellon University. TinyMUD was one of the first virtual environments to be ported to the Unix operating system which had become the de facto server OS of choice of Universities and large corporations by the mid nineties. This resulted in just about anyone with reasonable access permissions to a university or corporate server being able to host their own virtual environment for use by their friends and the general public. Such hosting activities were typically pretty short lived as a popular TinyMUD deployment would soon start impact the other work/applications that where being used on the same server, but there was a sufficient number of servers on the Internet that players could always find a new virtual environment to explore and play in.

Commercial virtual worlds found a new lease of life with the introduction of the first generation of Massively Multiplayer Online Games (MMOGs) in 1997 when Origin Systems launched Ultima Online and NCSoft's launched Linage. These two products were based on the world game models as the earlier MUD implementations but extended these models with a rich 3D interaction model. Rather than describing the virtual environments in text, the first generation MMOGs rendered a graphical representation of those environments in an isometric 3D form. Players were represented in a similar manner and rather than having to type “Go North” a player would just press the up arrow on their keyboard and their character or avatar would move or “walk” in real time towards the top of their display screen (e.g. virtual North).

These rich graphic environment made these MMOGs significantly more attractive to the average user who was used to the 3D graphical environments offered by games such as Doom or Quake and the MUD based game model proved to be as compelling as ever. Ultima online garnered 100,000 users within a year, and proved the MUD model could be commercially successful in the new Internet based online marketplace. So the modern MMOG market was born.

### SUMMARY

The invention is generally related to virtual environments, gaming environments, online communities, and interactive computing, and is specifically related to the use of cinematic montages to communicate travel progress inside a virtual environment.

An objective of the present invention is to provide a travel model and method for communicating travel progress that allows users to travel around a inside virtual environment in a manner more expedient than real-time user directed travel without breaking the illusion of reality (world model) associated with such an environment.

### BRIEF DESCRIPTION OF THE DRAWINGS

FIG. 1 shows an illustration of an example of a MUD text-based gaming session.

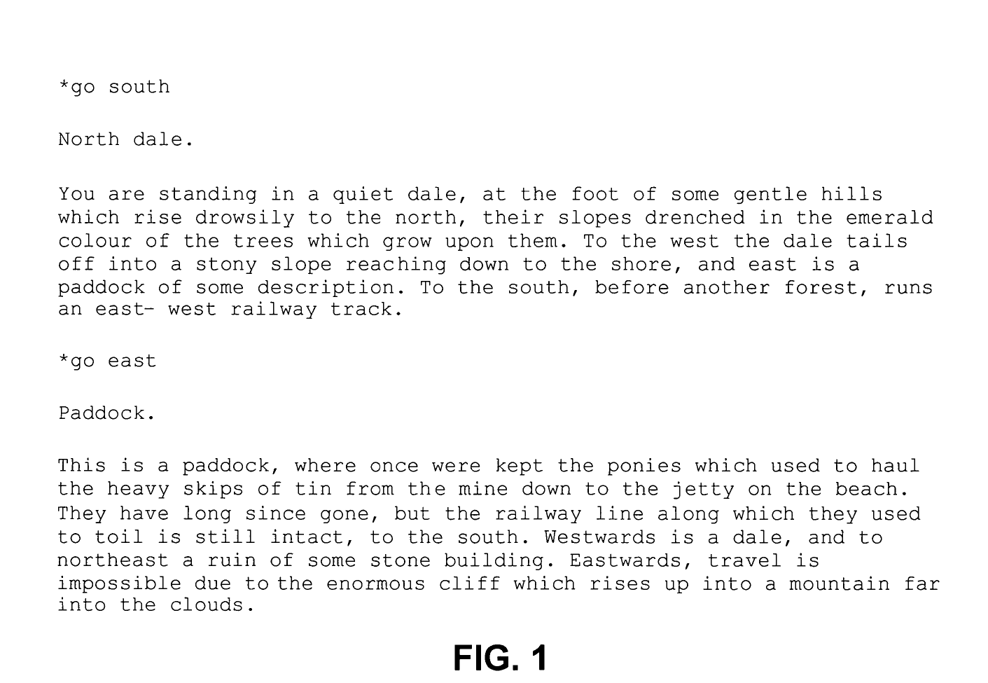

FIG. 2 shows an illustration of the cinematic montage based travel model.

### DETAILED DESCRIPTION

The objective of the present invention is to provide a travel model that allows users to move around inside a simulated real-world virtual environment in a manner that is more expedient than real-time user directed travel without breaking the illusion of reality (world model) associated with such an environment.

Typically travel models inside virtual environments are based around the following mechanisms:

Real-time navigation of virtual environment via avatar under user control. This travel model remains true to the world model and works well inside game environments such as MMOGs where users are willing to sacrifice the convenience of being able to move around the environment in an expedited fashion in order to further immerse themselves inside the game world. However such an approach is problematic in virtual environments that are outside of the game market such as, virtual team collaboration environments, distance learning environments or social networking environments. In these applications a real-time travel model would negate one of the major benefits associated with utilizing a virtual environment in these applications; that is the ability to users to congregate in a virtual environment without the travel time overhead associated with bringing a group of individuals together in the real world.

A StarTrek style teleporter based transport model in which users can select the location to where they wish to travel in the virtual environment and they are then instantly transported to that location. This model is often used in video game environments that are based on a science fiction based world models, however outside of these environments, the inclusion of a teleporter represents a break in the world model. In most environments a teleportation device appears incongruous given the virtual environment (for instance a medieval world). Finally teleportation mechanism breaks the illusion of distance and geography inside virtual environments.

Allow users to travel around the virtual environment by enabling avatars to fly around that environment in a manner similar to the comic book character Superman. This model is often used in science fiction and fantasy character based video game environments. However outside of those environments the inclusion of a flight based transport model breaks the world model in the similar manner to the introduction of a teleporter based transport model.

The present invention provides users with a virtual world travel model that combines the efficiency of movement associated with the Star Trek teleporter or Superman flight mechanisms without substantially compromising the virtual world model.

Travel is initiated with the user selecting the location they wish to visit from an environmental map or similar interface. After the user has made this selection they are presented with a cinematic montage of images showing the various locations that they may have encountered had they chosen to travel to the same location in real-time. This use of a montage to communicate travel progress allows environment designers to limit the amount of time associated with moving around the environment so avoiding the time overhead associated with moving around a large-scale environment in real-time while still allowing the designer to convey the scale and scope of the environment.

The duration of travel montages can be varied so that distance between locations are communicated by both the montage of travel images, and also in the duration of the travel montage. Travel to locations that are relatively close to the user would result in a short travel montage being displayed, and travel to a location further away would result in a travel montage that is longer in duration.

In addition to the user benefits associated with the present invention, it also provides the designers of virtual environments a significant benefit over the travel mechanisms examined earlier in this document. Specifically in that it allows designers to control the routes and sights that users take while moving around the environment so allowing for additional display opportunities of in environment advertisements and allows designers to route user traffic past environmental features (such as in game advertisements) that the designers may wish to emphasize.

Use Case

The virtual environment used in this example is based on a simulated environment representing New York City.

Users that wish to travel inside this environment are presented with a map representing the greater New York area. Users are prompted to select a location to which they wish to travel. After this selection has been made users are offered several travel options, broadly divided into two categories, automated travel and user directed real-time travel (users can also save their preferred travel mechanism).

If the user selects automated travel, they are guaranteed a travel time of less than 30 seconds in order to reach their selected destination. Travel progress is represented via a montage of travel scenes and a map overview, so that the user is presented with the highlights of a real time journey to the same destination.

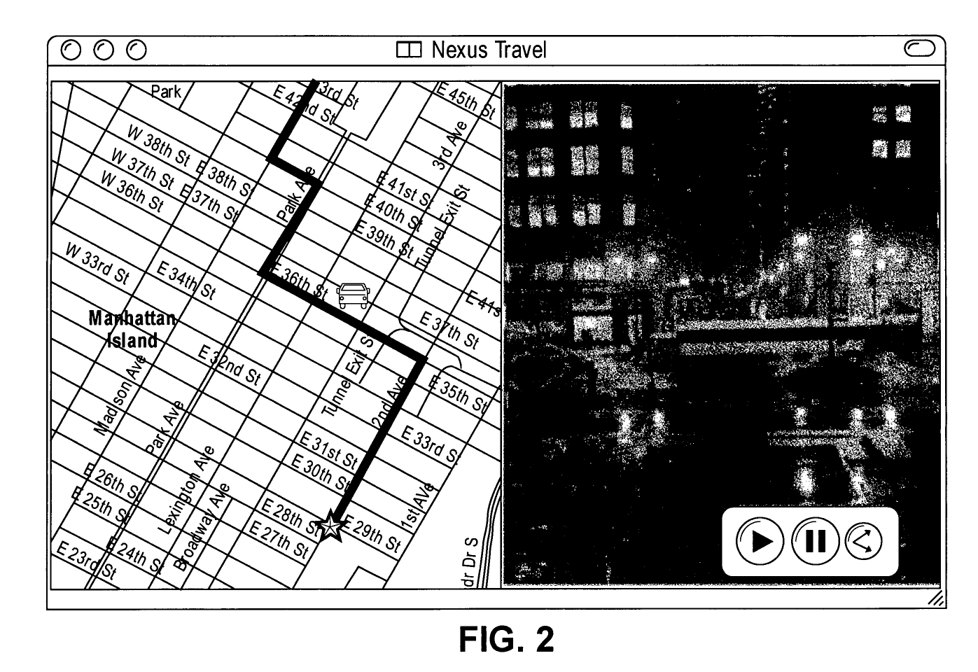

FIG. 2 demonstrates this mechanism in use. The screen is divided into two panels; the left panel shows travel progress via a map view, and the right panel shows a travel montage that is updated in synchrony with the map view. In this example the user is presented with a view of their mode of virtual transport (a bus in this case) as it passes through the intersection of Lexington and 36th Street.

The user is provided with a set of VCR style controls that allows them to control their progress. Users have the option of pausing their journey so that they may explore an interesting location.

### INDUSTRIAL APPLICABILITY

Advantages provided by the invention include: a time efficient travel model inside a virtual environment that doesn't break the world model (illusion of reality) associated with such an environment; the ability to display more in environment advertising when compared to user-controlled, flight or teleport models; the ability to direct user traffic past specific environmental objects to provide commercial benefits associated with potential sponsorship of those environments; the ability to direct user traffic past specific environmental objects to provide game play benefits that may include further exploration of that environment.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD ROMs, microdrive, and magneto optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for using a cinematic montage to communicate travel progress in a virtual environment, comprising:
a virtual environment including multiple locations therein;
a visual representation of the perspective of a user within said virtual environment;
an interface to allow the user to select a destination location to travel to within said virtual environment; and
wherein upon selecting a destination the visual representation changes to display a montage, from the users perspective, of travel through the virtual environment to the destination.

2. A method for using a cinematic montage to communicate travel progress in a virtual environment, comprising the steps of:
providing a virtual environment including multiple locations therein;
displaying a visual representation of the perspective of a user within said virtual environment;
allowing the user to select a destination location to travel to within said virtual environment; and
displaying a montage, from the users perspective, of travel through the virtual environment to the destination.
